(19) United States
(12) Patent Application Publication
(10) Pub. No.: US 2016/0284156 A1
(43) Pub. Date: Sep. 29, 2016

(54) Game Device

(71) Applicant: Wonderful World Group Limited, Macau (MO)

(72) Inventor: Kei Ian Choi, Macau (MO)

(73) Assignee: WONDERFUL WORLD GROUP LIMITED, Macau (MO)

(21) Appl. No.: 14/748,117

(22) Filed: Jun. 23, 2015

(30) Foreign Application Priority Data
Mar. 27, 2015 (HK) 15103147.9

(51) Int. Cl. G07F 17/32

(52) U.S. Cl. CPC G07F 17/323; G07F 17/3244; G07F 17/3293

(57) ABSTRACT

An embodiment of the utility model discloses a game device, involving the field of electronic equipment, which extends game modes and game device functions that enable the game to have more diversity and entertainment. The specific solutions are: a game device comprising a memory for storing game procedure codes, game records, rules of the game and game odds under the rules of the game; a controller for providing game modes setting function keys and bet selecting function keys under corresponding game modes, and sending a corresponding control command to a processor according to player's control and selection; a processor for executing the game procedure codes stored in the memory, so as to take charge of the core processing of the game; a display for displaying the rules of the game, game odds under the rules, and game interface images generated by the processor.

### FIELD OF THE UTILITY MODEL

The utility model relates to the field of electronic equipment, in particular to a game device.

### BACKGROUND OF THE UTILITY MODEL

Baccarat is a card game in which eight decks of cards are usually used, with 52 cards in each deck.

Traditionally, during a Baccarat game, the eight decks of cards are shuffled by a dealer and then placed within a box, and two to three cards are dealt to the banker and the player during one game, respectively; and then, a player may place a bet on any one of Banker, Player, Tie and Pair.

The rules of the traditional Baccarat game are specifically as follows: the numbers of all cards with numbers of J, Q, K and 10 are regarded as 0; and during one game, the total numbers of cards received by the banker are compared with the total numbers of cards received by the player, and the one with total numbers most approximate to 9 wins. Tie means that the total numbers of cards dealt to the banker are equal to the total numbers of cards dealt to the player. Pair means that the first two cards dealt to the banker and the player have the same number.

Electronic Baccarat game consoles in the prior art follow this traditional Baccarat game mode. That is, during a game, a processor of an electronic Baccarat game console may deal two to three cards to the banker and the player, randomly and respectively; and then the player may place a bet on any one of Banker, Player, Tie and Pair by a controller of the electronic Baccarat game console; and the processor may compare the total numbers to the banker with the total numbers to the player, and calculate the game result and bonuses based on the rules of this traditional Baccarat game.

However, the problem is that the existing electronic Baccarat game consoles, which are monotonous in game modes and functionally restricted as they follow the traditional Baccarat game mode, can not meet requirements on the development of entertainment products.

### SUMMARY OF THE UTILITY MODEL

The utility model provides a game device which extends game modes and game device functions that enable the game to have more diversity and entertainment.

To achieve this purpose, an embodiment of the utility model employs the following technical solution.

An embodiment of the utility model provides a game device, including:

a memory for storing game procedure codes, game records, rules of the game and game odds under the rules of the game;

a controller for providing game modes setting function keys and bet selecting function keys under corresponding game modes, and sending a corresponding control command to a processor according to player's control and selection, the control command containing player's selection of the game modes and player's bet information;

the processor for executing the game procedure codes stored in the memory, so as to take charge of the core processing of the game, and specifically executing the following operations: drawing N cards randomly and successively as hole cards; setting a game mode according to the player's selection; calculating the game result and bonuses based on the rules of the game according to the player's bet information and the hole cards; and generating and sending corresponding data of game interface images to a display, N=6 or N=4;

the display for displaying the rules of the game, game odds under the rules of the game, and the game interface images generated by the processor;

wherein, the player's bet information contains a bet combination type selected by the player, card numbers betted by the player in the bet combination type, and the player's bet amount.

In combination with the first aspect, in a first possible implementation, the controller is a touch screen; and

the controller is specifically for displaying the game mode setting function keys and the bet selecting function keys under corresponding game modes; and, receiving the control and selection of the player, generating and displaying corresponding bet result interface images, and sending a corresponding control command to the processor.

In combination with the first aspect, in a second possible implementation, the controller is a keyboard or a game pad;

the game mode setting function keys and the bet selecting function keys under corresponding modes are disposed on the controller; and

the processor is further used for generating and sending corresponding data of bet result interface images to the display according to the player's selection of the game modes and the player's bet information in the control command.

In combination with the first aspect and any one of the first possible implementation and the second possible implementation, in a third possible implementation, the game modes include traditional Baccarat, first M cards with same numbers, and combination of playing cards.

The game device provided by the embodiment of the utility model, compared with the existing electronic Baccarat game consoles which are monotonous in game modes and functionally restricted as they follow the traditional Baccarat game mode, may provide a variety of Baccarat game modes for the selection of players through this solution, thereby providing more game device functions for players. That is, this game device extends game modes and game device functions that enable the game to have more diversity and entertainment.

### BRIEF DESCRIPTION OF THE DRAWINGS

To describe the technical solutions in the utility model or in the prior art more clearer, drawings to be used in the description of the embodiments or prior art will be briefly introduced below. Apparently, the drawings to be described below are just some embodiments of the utility model, and other drawings may be obtained by those of ordinary skill in the art from those drawings without any creative efforts.

FIG. 1 is a structure diagram of a game device according to an embodiment of the utility model;

FIG. 2 is a structure diagram of an instance of the game device according to an embodiment of the utility model;

FIG. 3 is a structure diagram of an instance of another game device according to an embodiment of the utility model;

FIG. 4 is a structure diagram of an instance of yet another game device according to an embodiment of the utility model;

FIG. 5 is a flowchart of a game control method according to an embodiment of the utility model;

FIG. 6 is a structure diagram of an instance of still another game device according to an embodiment of the utility model;

FIG. 7 is a structure diagram of an instance of further another game device according to an embodiment of the utility model;

FIG. 8 is a structure diagram of an instance of further another game device according to an embodiment of the utility model; and

FIG. 9 is a structure diagram of an instance of further another game device according to an embodiment of the utility model;

### DETAILED DESCRIPTION OF THE PREFERRED EMBODIMENTS

The technical solutions in embodiments of the utility model will be described clearly and completely below in combination with drawings in the embodiments of the utility model. Apparently, the described embodiments are just some, but not all, of embodiments of the utility model. Based on the embodiments of the utility model, all other embodiments obtained by those of ordinary skill in the art without any creative efforts are included within the protection scope of the utility model.

In addition, terms “system” and “network” as used herein are usually used interchangeably. Term “and/or” as used herein merely describes an association relationship between associated objects, indicating that there may be three relationships. For example, “A and/or B” may be indicative of just A, both A and B, and just B. In addition, symbol “I” as used herein indicates an “or” relationship between the associated objects.

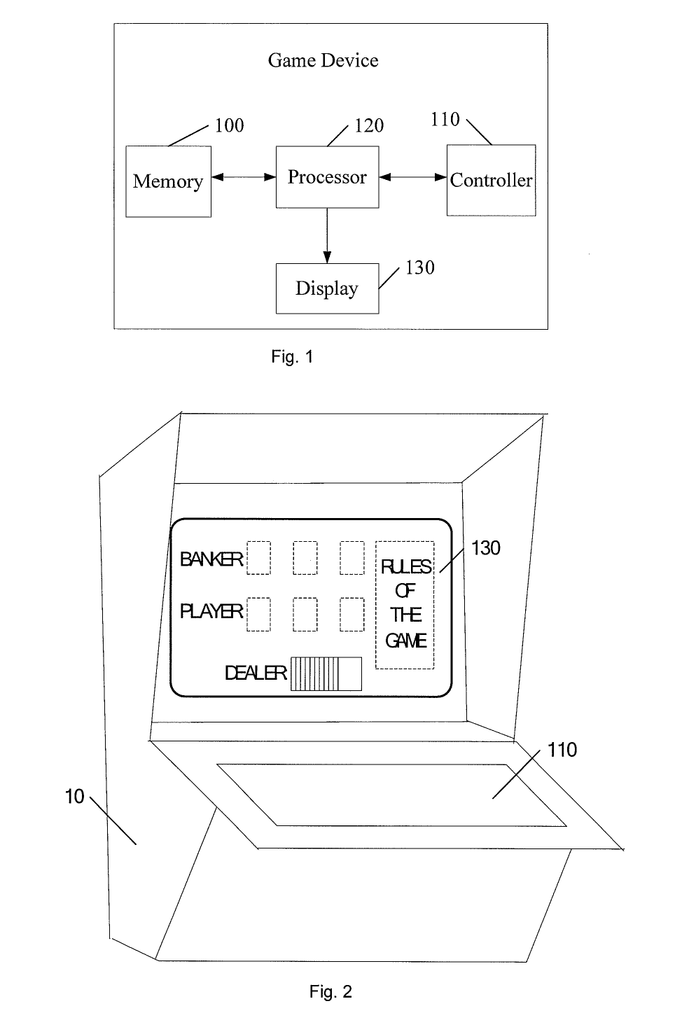

An embodiment of the utility model provides a game device, as shown in FIG. 1, including a memory 100, a controller 110, a processor 120 and a display 130;

the memory 100 is used for storing game procedure codes, game records, rules of the game and game odds under the rules;

the controller 110 is used for providing game modes setting function keys and bet selecting function keys under corresponding game modes, and sending a corresponding control command to the processor 120 according to player's control and selection, the control command containing player's selection of the game modes and player's bet information;

the processor 120 is used for executing the game procedure codes stored in the memory 100, so as to take charge of the core processing of the game, and specifically executing the following operations: drawing N cards randomly and successively as hole cards; setting a game mode according to the player's selection; calculating the game result and bonuses based on the rules of the game according to the player's bet information and the hole cards; and generating and sending corresponding data of game interface images to the display 130, N=6 or N=4; and

the display 130 is used for displaying the rules of the game, game odds under the rules of the game, and game interface images generated by the processor 120;

wherein, the player's bet information contains a bet combination type selected by the player, card numbers betted by the player in the bet combination type, and the player's bet amount.

Further, the controller 110 may be a touch screen; when the controller 110 is a touch screen, the controller 110 may have a display function, and the controller 110 may be specifically used for displaying the game mode setting function keys and the bet selecting function keys under corresponding game modes; and, receiving the control and selection of the player, generating and displaying corresponding bet result interface images, and sending a corresponding control command to the processor.

It is to be noted that, the processor 120 in the embodiment of the utility model may be implemented by an industrial computer system which takes charge of core processing of the game and executes the logical and flow control of the game, specifically including the following operations: setting the game modes, simulating a Baccarat game in which the dealer deals cards to the banker and the player randomly and to corresponding positions in a matrix array, simulating to place a bet, calculating the result and bonuses based on the rules of the game, and generating and sending corresponding data of images to the display 130. The memory 120 is used for storing game software programs and game records and may be implemented by a computer hard disk or flash memory card.

The game device provided by the embodiment of the utility model, when compared with the existing electronic Baccarat game consoles which are monotonous in game modes and functionally restricted as they follow the traditional Baccarat game mode, may provide a variety of Baccarat game modes for the selection of players through this solution, thereby providing more game device functions for players. That is, this game device extends game modes and game device functions that enable the game to have more diversity and entertainment.

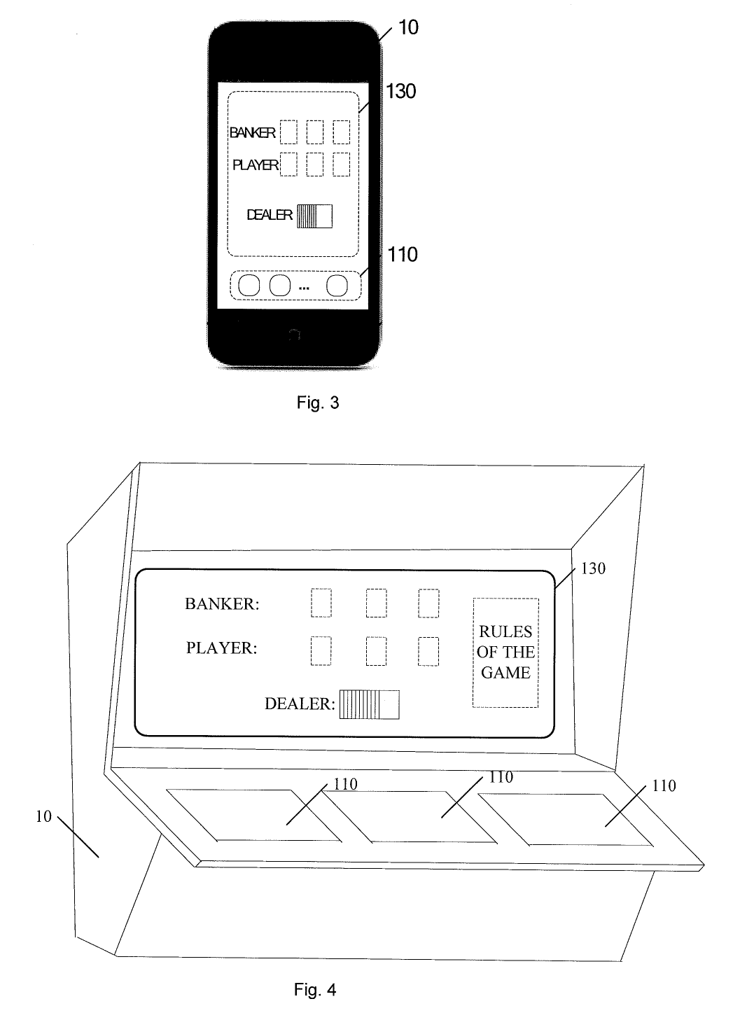

The game device provided by the embodiment of the utility model may be an electronic Baccarat game console having those functional modules and being capable of implementing those game functions. FIG. 2 is a diagram of an instance of the game device (i.e., electronic Baccarat game console) according to an embodiment of the utility model. Alternatively, the game device provided by the embodiment of the utility model may be any one of electronic terminals such as mobile phones, tablets and personal computers (PC), wherein, an electronic application of Baccarat capable of implementing those game functions may be installed in those electronic terminals. FIG. 3 is a diagram of an instance of a game device (i.e., mobile phone) in which an electronic application of Baccarat is installed, according to an embodiment of the utility model.

Further, in one application scenario of the embodiment of the utility model, the controller 110 may be a touch screen; and the controller 110 is specifically used for displaying the game mode setting function keys and the bet selecting function keys under corresponding game modes; and, receiving the control and selection of the player, generating and displaying corresponding bet result interface images, and sending a corresponding control command to the processor.

For example, when the game device is an electronic game console of Baccarat, the controller 110 may be a touch control terminal of this electronic game console of Baccarat, and the game mode setting function keys and the bet selecting function keys under corresponding game modes may be displayed on the touch screen. A player may set the game modes through touch operations on this controller 110, and a corresponding control command is sent to the processor 120 through the touch operation to the bet selecting function keys under a selected game mode.

When the game device is an electronic terminal, for example, mobile phone, tablet and personal computer, and the electronic terminal is a touch screen device, the controller 110 may be a control interface of an electronic application of Baccarat installed in this electronic terminal. This electronic terminal may display a control interface containing the game mode setting function keys and the bet selecting function keys under corresponding game modes. A player may set the game modes through touch operations on this control interface, and a corresponding control command is sent to the processor 120 through the touch operation to the bet selecting function keys under a selected game mode.

Further optionally, in another application scenario of the embodiment of the utility model, the controller 110 is a keyboard or a game pad; and the game mode setting function keys and the bet selecting function keys under corresponding game modes are disposed on the controller 110; and the processor 120 is further used for generating and sending corresponding data of bet result interface images to the display 140 according to the player's selection of the game modes and the player's bet information in the control command.

In this application scenario, the game mode setting function keys or a game pad and the bet selecting function keys under corresponding game modes or a game pad are disposed on the controller 110. A player may select a game mode in which he/she wants to place a bet by operating the keyboard or the game pad on the controller 110, and select a corresponding bet combination type by operating the bet selecting function keys or the game pad under a selected game mode.

Exemplarily, as shown in FIG. 2, the game device provided by the embodiment of the utility model includes a mainframe 10 having the processor 100 and the memory 120 installed therein, the controller 110 and the display 130.

Wherein, the display 130 is an information output device of the game device (i.e., electronic game console of Baccarat) for the Baccarat game, by which a player may receive all interface information of the game.

Exemplarily, the display 130 may be used for displaying initial interface information (for example, words “welcome to Baccarat game”) of the Baccarat game, IDs of the dealer, the banker and the player during a game as shown in FIG. 2, and game pictures from simulating the dealer to deal cards to the banker and the player to corresponding positions of the matrix array, etc. The controller 110 is an information input device of the game device for the Baccarat game. In FIG. 2, the display 130 may be implemented by a flat liquid crystal display; the controller 110 may be a touch screen on which the game mode setting function keys and the bet selecting function keys under corresponding game modes may be displayed, for example, this touch screen may be implemented by the capacitive touch technology. Of course, the game mode setting function keys and the bet selecting function keys under corresponding game modes on the controller 110 may also be a keyboard or a game pad.

Exemplarily, FIG. 2 is a diagram of the game device (i.e., electronic game console of Baccarat) according to an embodiment of the utility model. As shown in FIG. 2, the game device provided by the embodiment of the utility model includes a mainframe 10 having the processor 100 and the memory 120 installed therein, the controller 110 and the display 130.

It is to be noted that, the game device provided by the embodiment of the utility model may include at least one controller 110. As shown in FIG. 4, the game device provided by the embodiment of the utility model may include a plurality of controllers 110. That is, the game device provided by the embodiment of the utility model may allow several players to play simultaneously.

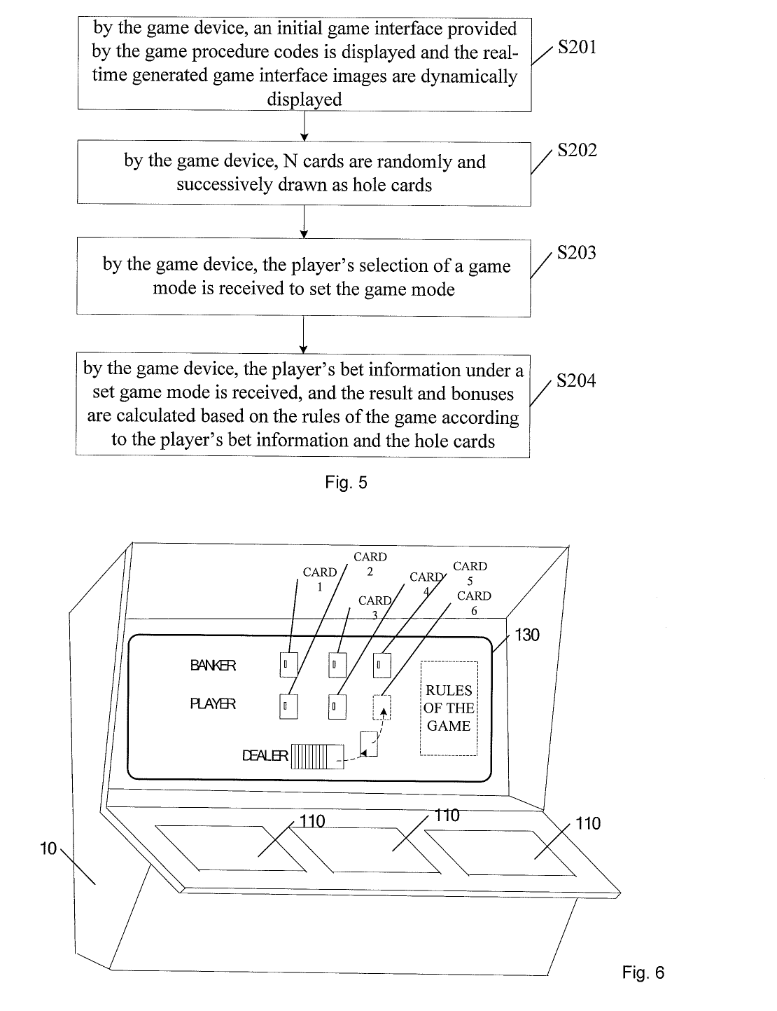

An embodiment of the utility model provides a game control method applicable to the above game device. As shown in FIG. 5, this control method includes:

S201: by the game device, an initial game interface provided by the game procedure codes is displayed and the real-time generated game interface images are dynamically displayed;

S202: by the game device, N cards are randomly and successively drawn as hole cards;

S203: by the game device, the player's selection of a game mode is received to set the game mode; and S204: by the game device, the player's bet information under a set game mode is received, and the result and bonuses are calculated based on the rules of the game according to the player's bet information and the hole cards;

wherein, the player's bet information contains a bet combination type selected by the player, card numbers betted by the player in the bet combination type, and the player's bet amount.

To facilitate those of ordinary skill in the art to understand the technical solutions of the utility model, the game control method and the game device of the utility model will be described by exemplarily regarding the game device as an electronic game console of Baccarat as shown in FIG. 2.

First, a player may turn on his/her electronic game console of Baccarat by operating the controller 110 of the electronic game console of Baccarat; and the processor 120 of the electronic game console of Baccarat may control the display 130 to display an initial game interface as shown in FIG. 2, upon receiving a game starting instruction sent by the user through the controller 110. As shown in FIG. 2, in the initial game interface, the rules of the game, IDs of the dealer, the banker and the player, specific positions where the dealer deals cards to the banker and the player, etc, may be included. Of course, in FIG. 2, a diagram of an initial Baccarat game interface is shown as an example. The initial game interface during a practical game includes, but is not limited to, game interface contents listed in the above instance. Optionally, words, for example, “welcome to Baccarat game” may be displayed on the display 130 prior to the display of the initial game interface.

Wherein, the controller 110 may provide game mode setting function keys for users. The game modes in the embodiment of the utility model include traditional Baccarat, first M cards with same numbers, and combination of playing cards.

Exemplarily, game mode “first M cards with same numbers” is a game in which, when a dealer draws N cards randomly and successively as hole cards and deals them to the banker and the player, the player places a bet on the front M cards with same numbers among the N cards dealt to the banker and the player sequentially. The player may place a bet on the front M cards with same numbers. In the embodiment of the utility model, eight decks of cards may be used, with 52 cards in each deck.

For example, game mode “first M cards with same numbers” will be described in the following Table 1, by taking N=6 and M≧4 as example.

TABLE 1

| | Award combination | | |
|---|---|---|---|
| Bet combination | having first four to six | Explanation on bet | |
| type | cards with same numbers | combination | Odds |
| 1. First four cards | A, 2, 3, 4, 5, 6, 7, 8, 9, | Any one of A to K (for | 500:1 |
| | 10, J, Q, K | example, hole cards: 2 [symbol] , | |
| | | 2♡, 2♦, 2 [symbol] , 5 [symbol] , 4♡; and | |
| | | bets on 2 [symbol] , 5♡, J♦, A [symbol] ) | |
| 2. First five cards | A, 2, 5, 6, 7, 10, J, Q, K | Any one of A, 2, 5, 6, 7, | 5000:1 |
| | | 10, J, Q, K (for example, | |
| | | hole cards: 5 [symbol] , 5♡, 5♦, | |
| | | 5 [symbol] , 5 [symbol] , 6♡; and bets on | |
| | | 7 [symbol] , 6♡, 5♦, Q [symbol] ) | |
| 3. First four cards | A, 2, 3, 4, 5, 6, 7, 8, 9, | Any one of A to K (for | 6000:1 |
| | 10, J, Q, K | example, hole cards: 6 [symbol] , | |
| | | 6♡, 6♦, 6 [symbol] , J [symbol] , 2♡; and | |
| | | bets on 6 [symbol] ) | |
| 4. Six cards | A, 2, 5, 6, 7, 10, J, Q, K | Any one of A, 2, 5, 6, 7, | 50000:1 |
| | | 10, J, Q, K (for example, | |
| | | hole cards: A ♡, A ♦, A | |
| | | [symbol] , A [symbol] , A ♡, A [symbol] ; and | |
| | | bets on A [symbol] , J♡, K♦, 2 [symbol] ) | |
| 5.First five cards | A, 2, 5, 6, 7, 10, J, Q, K | Any one of A, 2, 5, 6, 7, | 60000:1 |
| | | 10, J, Q, K (for example, | |
| | | hole cards: J♦, J♡, J♦, J [symbol] , | |
| | | J [symbol] , 2 [symbol] ; and bets on J♡) | |
| 6. Six cards | A, 2, 5, 6, 7, 10, J, Q, K | Any one of A, 2, 5, 6, 7, | 600000:1 |
| | | 10, J, Q, K (for example, | |
| | | hole cards: 5♦, 5♡, 5♦, | |
| | | 5 [symbol] , 5 [symbol] , 5 [symbol] ; and bets on | |
| | | 5♡) | |

In Table 1, the bet combination type 1 means that, a player may place a bet on any k (for example, k=3 or 4) numbers from A to K, and when the front four of the six hole cards have the same number and the numbers of the front four cards are the same as any one of the k numbers on which the player places a bet, the player may win bonuses in odds of 500:1; the bet combination type 2 means that, a player may place a bet on any k (for example, k=4 or5) numbers among A, 2, 5, 6, 7, 10, J, Q, K, and when the front five of the six hole cards have the same number and the numbers of the front five cards are the same as any one of the k numbers on which the player places a bet, the player may win bonuses in odds of 5000:1; the bet combination type 3 means that, a player may place a bet on any number from A to K, and when the numbers of the front four of the six hole cards are all the same as the number on which the player places a bet, the player may win bonuses in odds of 6000:1; the bet combination type 4 means that, a player may place a bet on any k (for example, k=4 or 5 or 6) numbers among A, 2, 5, 6, 7, 10, J, Q, K, and when the front six of the six hole cards have the same number and the number of the front six cards is the same as any one of the k numbers on which the player places a bet, the player may win bonuses in odds of 50000:1; the bet combination type 5 means that, a player may place a bet on any number among A, 2, 5, 6, 7, 10, J, Q, K, and the numbers of the front five of the six hole cards are all the number on which the player places a bet, the player may win bonuses in odds of 60000:1; and the bet combination type 6 means that, a player may place a bet on any number among A, 2, 5, 6, 7, 10, J, Q, K, and the numbers of all of the six hole cards are the number on which the player places a bet, the player may win bonuses in odds of 600000:1.

Exemplarily, game mode “combination of playing cards” is a game in which, when a dealer draws N cards randomly and successively as hole cards and deals them to the banker and the player, the player places a bet on a combination of M cards, for example, FLUSH, STRAIGHT, etc, among the N cards dealt to the banker and the player in the sequence. The player may place a bet on a combination of numbers of the M cards.

For example, game mode “combination of playing cards” will be described in the following Table 2, by taking N=6 and M≧4 as example.

TABLE 2

| | Combination | | |
|---|---|---|---|
| Bet combination | of | Explanation on bet | |
| type | playing cards | combination | Odds |
| 1. Four to | 3 KIND | Three cars with the same | 23:1 |
| six cards | | number plus three high | |
| | | cards (for example, 6♦, | |
| | | 6♡, 6♦, 7 [symbol] , A [symbol] , J♡) | |
| 2. Five to six | FLUSH | Five cards in the same | 21:1 |
| cards | | kind plus one high card | |
| | | (for example, 4♡, J♡, K♦, | |
| | | 7♡, 6♡, Q♡) | |
| 3. Five to | FULL | Three cards with the same | 22:1 |
| six cards | HOUSH | number, two cards with | |
| | | the same number, plus one | |
| | | high card (for example, | |
| | | J♡, J♦, K♦, 2 [symbol] , 2 [symbol] , 2♦) | |
| 4. Five to six | STRAIGHT | Five cards with successive | 23:1 |
| cards | | numbers but not in a same | |
| | | kind, plus one high card | |
| | | (for example, 3♦, 4♡, 5♦, | |
| | | 6 [symbol] , 7 [symbol] , Q♡) | |
| 5. Four to | 4 KIND | Four cards with the same | 30:1 |
| six cards | | number plus two high | |
| | | cards (for example, J♡, | |
| | | J♦, J♦, J [symbol] , 2 [symbol] , 7♦) | |
| 6. Five to six | 5 KIND | Five cards with the same | 300:1 |
| cards | | number plus one high card | |
| | | (for example, 10♡, 10♦, | |
| | | 10♦, 10 [symbol] , 10 [symbol] , 7♦) | |
| 7. Five to | STRAIGHT | Five cards with successive | 300:1 |
| six cards | FLUSH | numbers and in a same | |
| | | kind, plus one high card | |
| | | (for example, 2♦, 3♦, 4♦, | |
| | | 5♦, 6♦, 7 [symbol] ) | |
| 8. Five to | ROYAL | A, k, Q, J, 10 all in a same | 1800:1 |
| six cards | FLUSH | kind, plus one high card | |
| | | (for example, A [symbol] , K [symbol] , Q | |
| | | [symbol] , J [symbol] , 10 [symbol] , A [symbol] ) | |

In Table 2, the bet combination type 1 means that, a player may place a bet on any number from A to K, and when the numbers of any three of the six hole cards are the number on which the player places a bet and the numbers of the other three cars are different from the number on which the player places a bet, the player may win bonuses in odds of 3:1; the bet combination type 2 means that, a player may place a bet on five cards in a same kind from A to K, and when the numbers of any five of the six hole cards are the five cards in a same kind on which the player places a bet, the player may win bonuses in odds of 21:1; the bet combination type 3 means that, a player may place a bet on three cards with the same number from A to K and two cards with the same number other than those three cards, and when the numbers of three cards among any five of the six hole cards are the same as the number of three cards with the same number on which the player places a bet and the numbers of two cards among any five of the six hole cards are the same as the number of two cards with the same number on which the player places a bet, the player may win bonuses in odds of 22:1; the bet combination type 4 means that, a player may place a bet on five cards with successive numbers but not in a same kind from A to K, and when the numbers of any five of the six hole cards are the numbers of five successive cards on which the player places a bet, the player may win bonuses in odds of 23:1; the bet combination type 5 means that, a player may place a bet on any number from A to K, and when the numbers of any four of the six hole cards are the number on which the player places a bet and the numbers of other two cards are different from the number on which the player places a bet, the player may win bonuses in odds of 30:1; the bet combination type 6 means that, a player may place a bet on any number from A to K, and when the numbers of any five of the six hole cards are the number on which the player places a bet and the number of other one card is different from the number on which the player places a bet, the player may win bonuses in odds of 300:1; the bet combination type 7 means that, a player may place a bet on five cards with successive numbers and in a same kind from A to K, and when the numbers of any five of the six hole cards are the same as the numbers of five cards in a same kind on which the player places a bet, the player may win bonuses in odds of 300:1; and the bet combination type 8 means that, a player may place a bet on five cards in a same kind among A, K, Q, J, 10, and when the numbers of any five of the six hole cards are the numbers of five cards in a same kind on which the player places a bet, the player may win bonuses in odds of 1800:1.

The traditional Baccarat game mode is the one introduced in the background of the utility model, and will not be repeated here.

A player may select a game mode he/she wants to play through the game mode setting function keys on the controller, and select a bet combination type under a corresponding game mode. For example, if a player selects a game mode “first M cards with the same number”, he/she may select any one of the six bet combination types as shown in Table 1. Then, the player may place a bet on a corresponding card number in the selected bet combination type through the controller, and input the bet amount. For example, if the player selects the bet combination type 4 (i.e., first four cards) among the six bet combination types as shown in Table 1, this player may place a bet on any number from A to K through the controllers. At the end of placing a bet by the player, the bet result of this player may be displayed on the controller.

It is to be noted that, as shown in FIG. 4 or FIG. 6, the game device provided by the embodiment of the utility model may include a plurality of controllers 110. That is, the game device provided by the embodiment of the utility model may allow several players to play simultaneously. In this case, the players may select different game modes and place bets on their own controllers.

After the Baccarat game starts, before the player places a bet through the controller/during this process, the processor may simulate the specific process in which the dealer in the Baccarat game deals cards to the banker and the player, generate corresponding game interface images, and control the display to display the images. As shown in FIG. 6, a dealer may deal the cards to the banker and the player in a sequence of card 1, card 2, card 3, card 4, card 5 and card 6, and place each card with its back up at a corresponding position. After all players place a bet successfully or the players send a draw control instruction to the processor through the controller, the processor may control the display to display corresponding draw pictures, calculate the game result and bonuses based on the rules of the game according to the bet information of each player and the hole cards, and generate and send corresponding data of game interface images to the display. The display may display the winning result of each player.

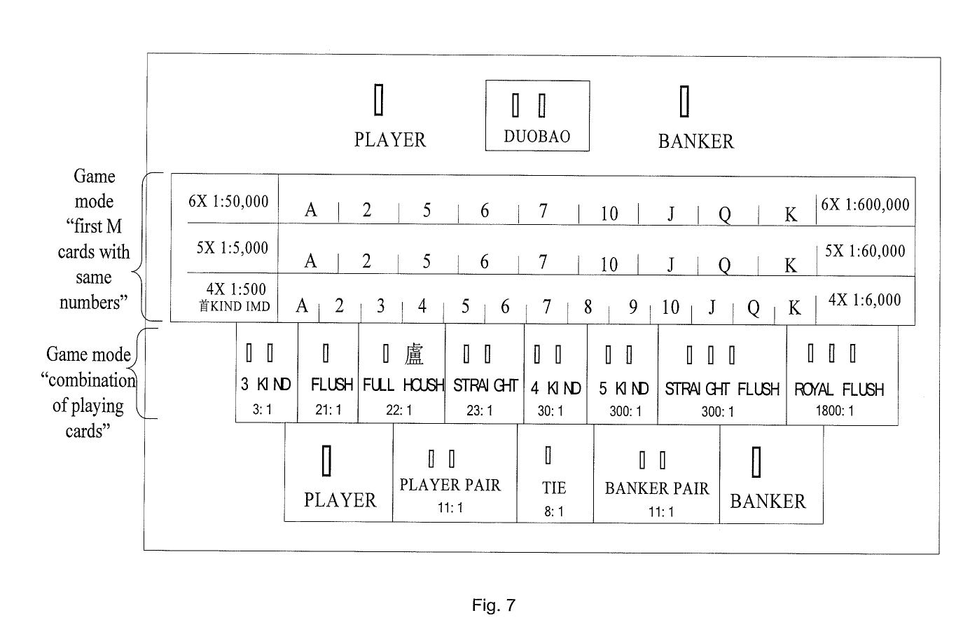

It is to be noted that, instances of the game device of the embodiment of the utility model are given in FIG. 2, FIG. 3, FIG. 4 and FIG. 6 only as examples and the game device of the embodiment of the utility model includes but is not limited to the instances of the game device listed above. FIG. 7 is a diagram of an instance of a game device according to an embodiment of the utility model.

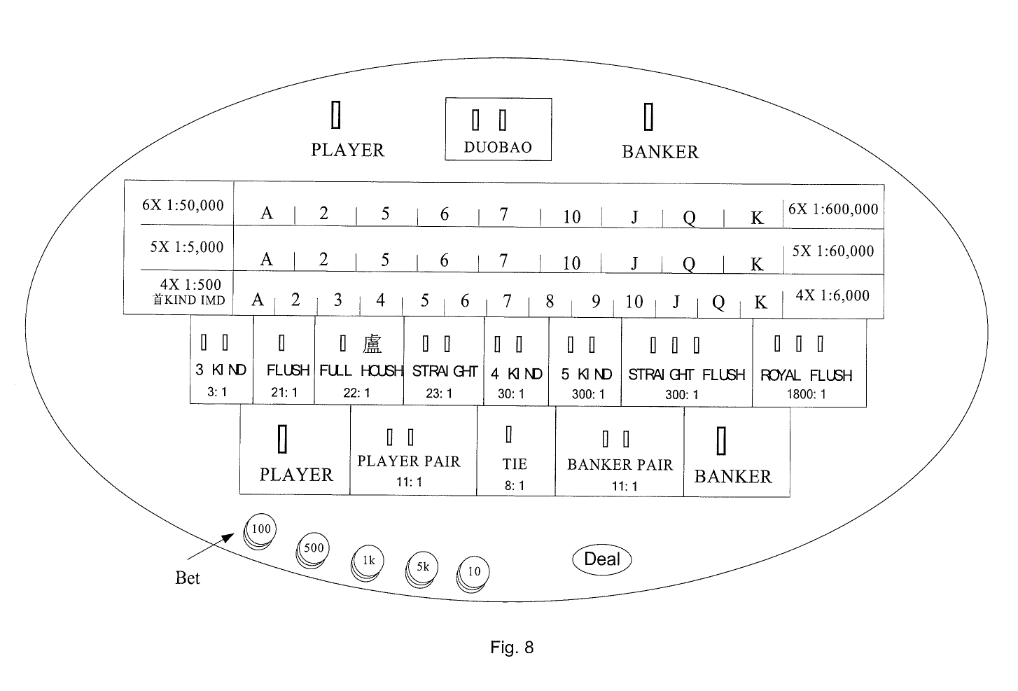

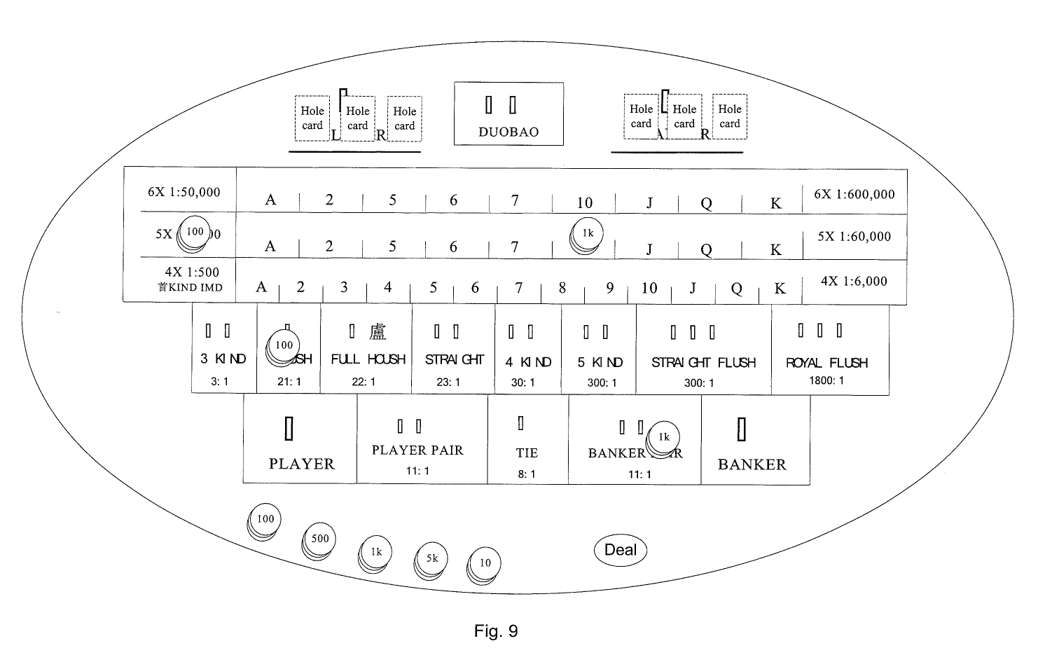

A player may place a bet as shown in FIG. 8 on game modes as shown in Table 1 or 2, to obtain the bet results as shown in FIG. 9.

It is to be noted that, the specific functions and usages of the Baccarat game device as shown in FIG. 7 to FIG. 9 are the same as those of the foregoing game device of the utility model, and will not be repeated here.

Furthermore, the odds, under different rules in different game modes, are given in the embodiment of the utility model only as examples. The odds in the embodiment of the utility model include but are not limited to the odds listed above, and will not be repeated here.

It is to be noted that, when the game device is an electronic terminal, for example, mobile phone, tablet and personal computer, the specific game modes and rules of this game device are similar to those in the case that this game device is an electronic game console of Baccarat, and will not be repeated here.

The game device provided by the embodiment of the utility model, when compared with the existing electronic game consoles of Baccarat which are monotonous in game modes and functionally restricted as they follow the traditional Baccarat game mode, may provide a variety of Baccarat game modes for the selection of players through this solution, thereby providing more game device functions for players. That is, this game device extends game modes and game device functions that enable the game to have more diversity and entertainment.

Furthermore, the game device provided by the embodiment of the utility model may provide Baccarat games in different game modes for several players simultaneously, further enabling the game to have more diversity and entertainment.

Through the description of the above implementations, it may be clearly understood by those skilled in the art that, for sake of convenience and simplicity of description, the division of the foregoing functional modules is described only as examples. During practical applications, those functions may be distributed to and accomplished by different functional modules if required. That is, the internal structure of the device may be divided into different functional modules to accomplish all or part of functions described above. The specific working processes of the systems, devices and units described above may refer to corresponding processes in the foregoing method embodiments, and will not be repeated here.

In the several embodiments provided in this application, it should be appreciated that the disclosed systems, devices and methods may be implemented by other ways. For example, the embodiments of the devices described above are merely exemplary. For example, the division of the modules or units is merely a logically functional division, and when in practical implementations, there may be additional division ways. For example, a plurality of units or assembles may be combined or may be integrated onto another system, or, some features may be omitted or not executed. Another point is that the displayed or discussed coupling or direct coupling or communicative connection therebetween may be made by some interfaces, and the indirect coupling or communicative connection between the devices or units may be electrical, mechanical or in other ways.

Units, described as separating components, may or may not be physically separated; and components, displayed as units, may or may not be physical units, i.e., may be located at one place or may be distributed onto a plurality of network elements. Part or all of the units may be selected, according to actual demands, to implement the purpose of the solution of the embodiment.

In addition, functional units in various embodiments of the utility model may be integrated in one processing unit, may physically exist as a single unit alone, and two or more than two units may also be integrated in one unit. The integrated unit may be implemented by hardware and may also be implemented by software functional units.

The integrated unit, when sold or used as a separate product if implemented by software functional units, may be stored in one computer readable storage medium. On the basis of such understanding, substantially the technical solution of the utility model or the part thereof contributing to the prior art or all or part of this technical solution may be embodied as a software product stored in one storage medium including a number of instructions that enable a computer device (it may be a personal computer, a server or a network device, etc.) or processor to execute all or part of steps of the method of various embodiments of the utility model. The foregoing storage medium includes various media in which procedure codes may be stored, such as USB flash disks, mobile hard disks, ROMs (read-only memories), RAMs (random access memories), disks or discs.

The foregoing contents are merely specific implementations of the utility model, and the protection scope of the utility model is not limited thereto. Any changes or replacements easily obtained by those of ordinary skill in the art within the disclosed technical scope of the utility model should be included within the protection scope of the utility model. Hence, the protection scope of the utility model should be defined by the protection scope of the appended claims.

1. A game device comprising:
a memory for storing game procedure codes, game records, rules of the game and game odds under the rules of the game;
a controller for providing game modes setting function keys and bet selecting function keys under corresponding game modes, and sending a corresponding control command to a processor according to player's control and selection, the control command containing player's selection of the game modes and player's bet information;
the processor for executing the game procedure codes stored in the memory, so as to take charge of core processing of the game, and specifically executing the following operations: drawing N cards randomly and successively as hole cards; setting a game mode according to the player's selection; calculating the game result and bonuses based on the rules of the game according to the player's bet information and the hole cards; and generating and sending corresponding data of game interface images to a display, N=6 or N=4; and
the display for displaying the rules of the game, game odds under the rules of the game, and game interface images generated by the processor;
wherein, the player's bet information contains a bet combination type selected by the player, card numbers betted by the player in the bet combination type, and the player's bet amount.

2. The game device according to claim 1, wherein the controller is a touch screen; and
the controller is specifically used for displaying the game mode setting function keys and the bet selecting function keys under corresponding game modes; and, receiving control and selection of the player, generating and displaying corresponding bet result interface images, and sending a corresponding control command to the processor.

3. The game device according to claim 1, wherein the controller is a keyboard or a game pad;
the game mode setting function keys or a game pad and the bet selecting function keys or a game pad under corresponding modes are disposed on the controller; and
the processor is further used for generating and sending corresponding data of bet result interface images to the display according to the player's selection of the game modes and the player's bet information in the control command.

4. The game device according to claim 1, wherein the game modes comprise traditional Baccarat, first M cards with same numbers, and combination of playing cards.
